(19) United States
(12) Patent Application Publication
(10) Pub. No.: US 2013/0250181 A1
(43) Pub. Date: Sep. 26, 2013

(54) METHOD FOR FACE REGISTRATION

(71) Applicants: Qianxi Zhang, Beijing (CN); Jie Zhou, Beijing (CN); Wei Zhou, Beijing (CN)

(72) Inventors: Qianxi Zhang, Beijing (CN); Jie Zhou, Beijing (CN); Wei Zhou, Beijing (CN)

(73) Assignee: THOMSON LICENSING, Issy de Moulineaux (FR)

(21) Appl. No.: 13/989,983

(22) PCT Filed: Dec. 29, 2010
(86) PCT No.: PCT/CN2010/002192

§ 371 Date: May 28, 2013

(51) Int. Cl. G06K 9/00; H04N 5/44; G06F 3/0487

(52) U.S. Cl. CPC G06K 9/00228; G06F 3/0487; H04N 5/4403
USPC 348/734; 715/762; 382/118

(57) ABSTRACT

A user interface automatically retrieves the preference of a user when a user interacts with a system by detecting his/her image and matching the user image database. The image database stores the physical features of users of a system, which can differentiate between the users of the system. A user registration method transparently registers user into the image database through clustering using learned distance metric from user images. A method of learning a distance metric identifies pair-wise constraints from data points and maximizes the margin between the distances of a first set of pairs and a second set of pairs, which can be further solved via semi-positive definite programming.

### FIELD OF THE INVENTION

This invention relates to the field of face recognition and metric learning, particularly involving the technology of face registration.

### BACKGROUND OF THE INVENTION

A traditional way of controlling systems at home, such as appliances, is by manually setting the system to a desired mode. It would be appealing if the systems that users interface with are automatically controlled. For systems like TVs, a user would prefer to have a mechanism which learns the user's preference for TV channels or the type of TV programs he/she mostly watched. Then, when a user shows up in front of the TV, the corresponding settings are loaded automatically.

User recognition has been a hot area of computer technology in the past decades, such as face recognition, gesture recognition etc. Taking face recognition as an example, the traditional registration process is usually complicated. Users need to enter their IDs, and in the meanwhile a number of face images are taken under pre-defined conditions, such as certain lighting environment and fixed viewing angles of the face.

Every user image is a vector in a high dimensional space. Clustering them directly according to the Euclidean metric may result in undesired results, because the distribution of the user images of one person is not spherical but lamellar. The distance between two images of the same person under different conditions is most likely larger than the distance between different persons under the same conditions. To solve this problem, learning a proper metric becomes critical.

In the video source, there are some useful pair-wise constraints of the images, which can help to train the system to learn the metric. For instance, two user images captured from two near frames belong to the same person, and two user images captured from one frame belong to different persons. Those two kinds of pair wise constraints are defined as similar pair constraints and dissimilar pair constraints. The problem of learning a metric under pair-wise constraints is called semi-supervised metric learning. The main idea of the traditional semi-supervised metric learning is to minimize the distances of similar sample pairs while the distances of dissimilar sample pairs are constrained strictly. Since the treatments of similar and dissimilar sample pairs are unbalanced, this method is not robust to the number of constraints. For example, if the number of dissimilar pairs is much higher than that of similar pairs, the constraints of the dissimilar sample pairs become too loose to make a enough difference, and this method cannot find a good metric. In another distance metric learning method, the real object to be maximized is the interface value of the two classes of distances, which is the middle value of the maximum distance of the class with smaller distance values and the minimum distance of the other class with larger distance values, rather than the width of the margin, which is the difference between said maximum distance and said minimum distance of the two classes. Thus, the systems are not robust.

### SUMMARY OF THE INVENTION

This current invention describes a user interface which can analyze the user's preference of interacting with a system, and automatically retrieve the preference of a user when a user interacts with the system and his/her image is detected and matches the user image database. It comprises a database of images corresponding to physical features of users of a system. The physical features of the users differentiate between the users of the system. A video device is employed to capture user images when a user interfaces with the system. A preference analyzer gathers user preferences of the system on a basis of user interaction with the system and segregates the preferences to create a set of individual user preferences corresponding to each of the users of the system. The segregated user preferences are stored in a preference database, and are correlated through a correlator with the users of the system based on the images in the database of images. The correlator applies the individual user preferences related to a particular user of the system which has been captured by the video device when the user interfaces with the system.

The current invention further includes a user registration method to register user into the image database. In one embodiment of the invention, a sequence of pictures of users is accessed, from which images are detected corresponding to physical features of users that differentiate between the users. A distance metric is determined using said detected images, and said images are clustered based on distances calculated using said distance metric. The clustering results are used to register users.

Another embodiment of the invention provides a method for updating user registration, which comprises the steps of accessing a sequence of pictures of users; detecting images from said sequence of pictures, wherein the images correspond to physical features of users that differentiate between the users; identifying constraints among detected images; clustering said images based on distances calculated using existing distance metric; verifying said clustering results with said identified constraints; and, updating the user registration based on said clustering results and verification results.

Another embodiment of the invention provides a method of determining a distance metric, A, comprising the steps of: identifying a plurality of pairs of points, (xᵢ,xⱼ), having a distance between the points, wherein the distance, d_{A}, is defined based on the distance metric, A, as

d_{A}(xᵢ,xⱼ)=∥xᵢ−xⱼ∥_{A}=\sqrt{(xᵢ−xⱼ)′A(xᵢ−xⱼ)};

selecting a regularizer of the distance metric A; minimizing said regularizer according to a set of constraints on the distances, d_{A} between said plurality of pairs of points to obtain a first value of said regularizer; and, determining the distance metric, A, by finding the one that achieves a value of said regularizer, which is less than or equal to the first value.

### BRIEF DESCRIPTION OF THE DRAWINGS

The above features of the present invention will become more apparent by describing in detail exemplary embodiments thereof with reference to the attached drawings in which:

FIG. 1 is a block diagram illustrating a user interface in accordance with present invention;

FIG. 2 is a flow chart illustrating the face registration process in accordance with the present invention;

FIG. 3 is a flow chart illustrating the process of building the face image database based on input video segments;

FIG. 4 is a flow chart illustrating the process of updating the face image database based on input video segments;

FIG. 5 is a diagram illustrating the merging of video segments using RFID labels in accordance with the present invention;

FIG. 6 is a flow chart illustrating a face registration process when the RFID labels are available;

FIG. 7 is a flow chart illustrating the face registration process in accordance with a preferred embodiment of the invention.

FIG. 8 is the results showing the performance of the invented MMML metric learning method.

### DETAILED DESCRIPTION

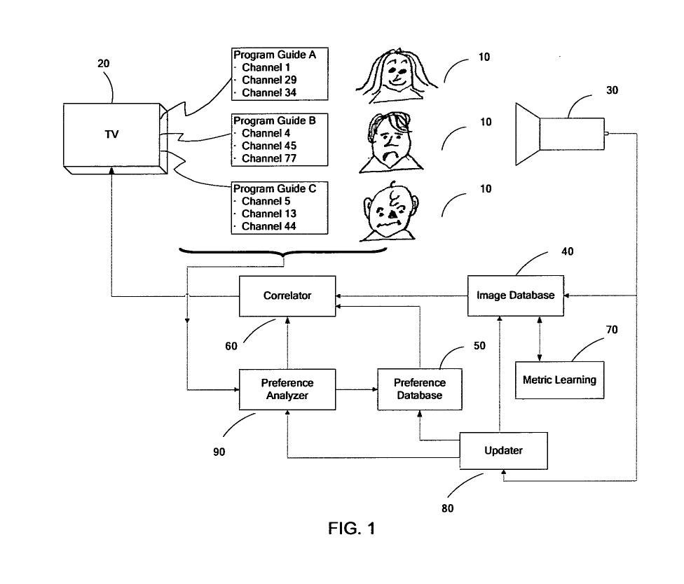

The current invention is a system that customizes services to users 10 according to their preferences based on physical feature recognition and registration mechanisms, such as face, gesture etc. which can differentiate between users. The customization is preferably accomplished transparently as will be described below. FIG. 1 illustrates the system using TV as an example of the system that a user 10 is interfacing with, and using a face as an example of the physical feature. A video device 30, such as a camera, is set up in a working environment, such as on top of a TV set 20 in the living room, to capture the images of users when the users interface with the system without restrictions on users, such as their locations relative to the camera 30 or their angles etc. Face images for each user are extracted from the video and registered to each user to build an image database 40 of users. A preference analyzer 90 gathers user preferences of the system when a user is interacting with the system, such as users' favorite channels, preferred genre of movies, and segregates the preferences to create a set of individual user preferences corresponding to each of the users of the system. The gathered user preferences are stored in the preference database 50. A correlator 60 links the user preference database 50 and the image database 40 by mapping the image for each individual user to his/her corresponding preference set. When a newly captured image of a user comes in, it is registered with the image database 40 and then the correlator 60 is triggered to retrieve the preference data of the corresponding user which is then sent to the system for automatic setup. A metric learning module 70 is employed to facilitate the registration process, as well as the database building process. If the captured user image is new to the image database, i.e. a new user, the updater 80 updates the image database, and initiates the preference analyzer 90 to build and store the preference of the user to the preference database 50. The correlator 60 is employed to link the preference profile with the user.

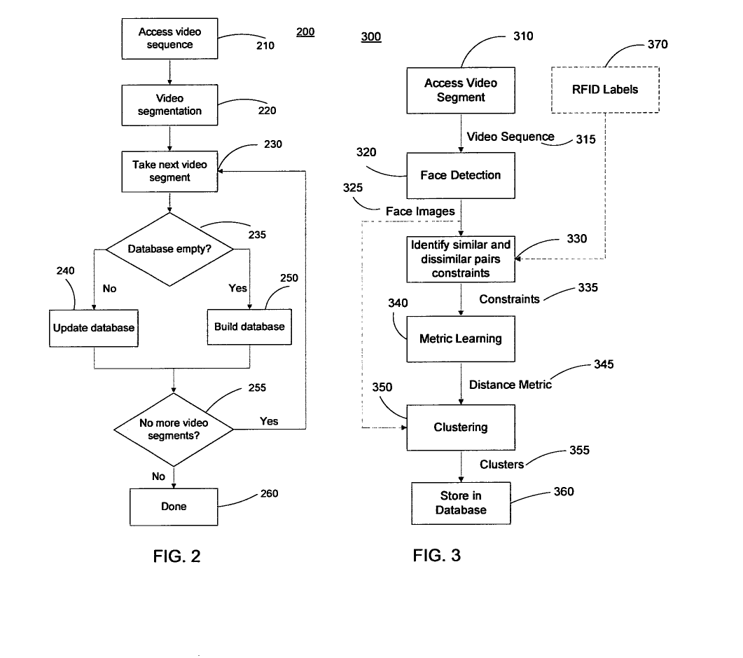

FIG. 2 illustrates an embodiment of a method of feature registration 200 using face as an example feature. It will be appreciated by those with skill in the art that the process is not restricted to face and is applicable to any other features as well. An advantage of the current invention is that the feature registration process is transparent to users. Unlike the traditional face registration process, wherein users need to enter their ID and are taken a number of face images under certain conditions, such as lighting and the viewing angle of the face, a preferred embodiment extracts the face images from the video source directly and works on registration based on the extracted face images. To facilitate such a process, the video source is preferably processed first. In a preferred embodiment, the video is divided into segments. Each segment consists of similar consecutive frames, e.g. with the same users and under similar conditions. By segmenting the video, it is ensured that the users appearing in one segment are highly related which eases the process of identifying similar and dissimilar pairs of images as shown later. Since the registration process is transparent to users, the segmentation should be done automatically. Thus methods like scene detection can be employed in the segmentation process. Since the relationship among users, such as two images belonging to the same person or different persons, can only be guaranteed within one segment in this embodiment, the registration process is done segment by segment. When the system starts to run, the image database is empty. Thus a process to build the database is performed. Later on, for any incoming video sequences, only database update is needed.

The input video sequences are obtained in a video access step 210, e.g. from video device 30 and are divided into segments, in video segmentation step 220, e.g. according to scene cuts, such that each video segment consists of consecutive frames containing at least one person's face. For each of the segments retrieved in step 230, a condition 235 of whether the image database empty is verified. If the condition 235 is satisfied, that is, the image database is empty at the moment the current segment is being processed, an image database is built based on the current segment according to step 250; otherwise, the database is updated following step 240. The steps of 235, 240 and 250 are repeated until condition 255 is satisfied, i.e. there are no more video segments. The registration process stops at step 260.

The steps of building an image database 250 is illustrated in more detail in FIG. 3. For an input video segment, face extraction is performed. From the extracted face images, pair-wise constraints are identified. In a preferred embodiment, similar pair constraints and dissimilar pair constraints are used. The similar pair constraint is identified as two face images of the same person; the dissimilar pair constraint is identified as two face images of two different persons. Since the step 220 has segmented the video into consistent consecutive frames, it is very likely that one segment contains the same group of persons. Thus, the similar and dissimilar constraints can be relatively easily identified. For example, two face images belonging to one frame are identified as dissimilar pairs, since they must belong to different persons. Face images residing at similar locations in two consecutive frames are identified as similar pairs, because in general, face images of the same person would not move too significantly from one frame to the next frame. The identified constraints along with the face images are fed into a metric learning mechanism to obtain a metric so that the face images can be clustered, using such a metric, into classes with each class corresponding to each user. The reason that metric learning is used here is that one metric used for clustering in one scenario may not be satisfactory in a different scenario. For example, the distribution of the face images of one person is not spherical but lamellar. If Euclidean distance is used, the distance between two images of the same person under different conditions is most likely larger than the distance between different persons under same conditions. To overcome this problem, learning a proper metric becomes critical. Various metric learning methods can be used in this step. In a preferred embodiment of this invention, Maximum Margin Metric Learning (MMML) method is employed. The details on the MMML will be discussed below. Once the learning metric is obtained, clustering can be performed to generate clusters, and each cluster is marked with each user's identify in the database.

In FIG. 3, a video segment access step 310 is first performed to obtain the video sequence 315. Face detection step 320 is employed to detect face images 325 from the video segment 315. An exemplar face detection method can be found in Paul Viola and Michael Jones, “Robust Real-Time Face Detection,” International Journal of Computer Vision, Vol. 57, pp. 137-154, 2004. From the detected face images 325, similar pairs of face images and dissimilar pairs of face images are identified in step 330 as constraints 335. The identified constraints on similar pairs and dissimilar pairs of face images 335 are then fed into metric learning step 340 for obtaining a distance metric. Upon obtaining a distance metric 345, a clustering step 350 is employed to perform clustering on the face images 325 to group the face images into several clusters, each representing one person, and thus identifying each individual user in the input video. The face images, clustering results, the distance metric and other necessary information are stored in the database at step 360.

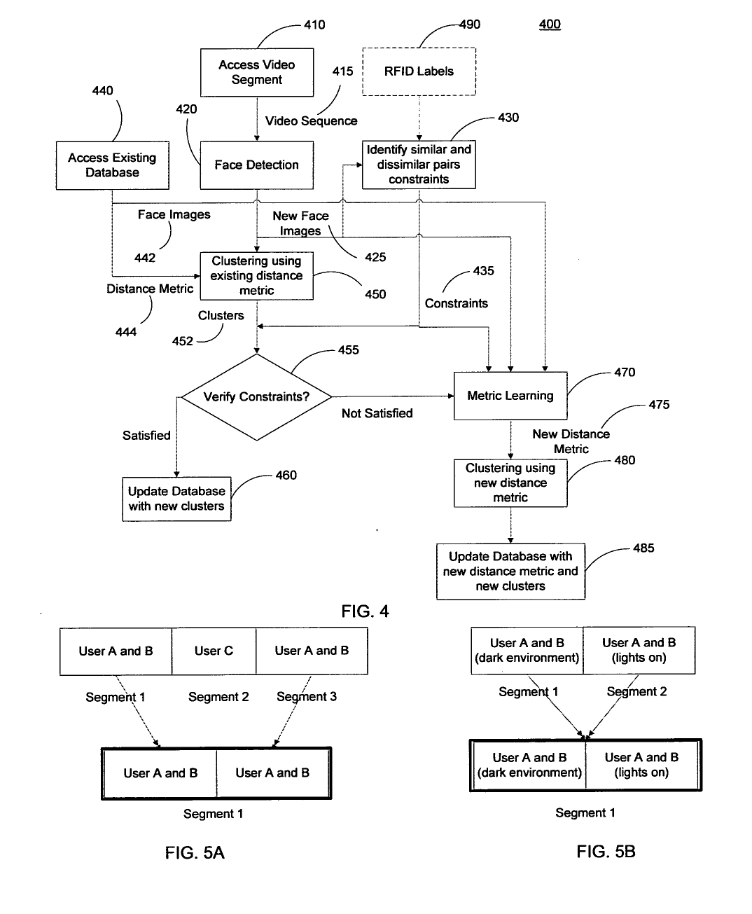

FIG. 4 shows the process 400 of updating an existing database based on a new input video segment. After the video sequence 415 is obtained, a face detection step 420 is started to generate face images in the video sequence 415. Preferably, the existing database has already had its distance metric learned from previous video segments. In such a scenario, the metric is first utilized to perform clustering on the detected face images. That is, the detected face images 425 are input into a clustering step 450 based on the distance metric 444 from the existing database. Since the metric is learned from previous video segments that the system has encountered, it may not be valid for the current segment which may introduce new aspects/constraints that the exiting metric learning does not take into account. Therefore, the generated clusters 452 are input into a condition checker 455. The conditions to be verified are the constraints 435 identified in step 430 as similar and dissimilar pairs of images for the current segment. If the conditions in 455 are satisfied, then the new clusters are updated in the database and process is finished at step 460. Otherwise, the existing metric does not capture the characteristics of the current video segment and need to be updated. Thus, a metric learning step 470 is started to re-learn the metric based on the identified constraints 435, the existing constraints from the database, the face images 442 from existing database and new face images 425. The new distance metric 475 learned from step 470 is then used to perform the clustering 480, whose results are updated in the database along with the new distance metric. In a preferred embodiment, MMML metric learning method is employed, whose details are disclosed later.

In a different embodiment, e.g. in a home environment, users could carry RFID devices or other wireless connectors and thus the captured video has detected RFID labels associated with it, i.e. a certain RFID or multiple RFIDs are detected and associated to frames within a certain period of time. The RFID labels can be useful in combining segments generated in step 220. Each of segments is a consistent set of consecutive frames. However, between different segments, such relationship is not guaranteed or hard to identify, but may exist. As a result, the constraints extracted are isolated and may cause the inferior performance of the metric learning. By combining those segments and linking the constraints together, the metric learning accuracy can be improved. RFID labels provide such a mechanism to combine the segments. For instance, a video sequence is segmented based on scenes into 3 segments as shown in FIG. 5A, wherein segment 1 and 3 are frames with user A and B present, while segment 2 contains only user C. If RFID labels exist for user A and user B in segments 1 and 3, merging segment 1 and 3 into a new segment 1 is possible since it is known from the RFID detection that both segments contains user A and user B and they are highly related. Similarly, as shown in FIG. 5B, a video sequence, which is segmented into two segments due to the lighting condition change during capture, will be identified as one segment by using RFID label information. RFID label information reduces the number of segments, and thus reduces the number of loops in FIG. 2 and leads to a faster face registration process. In the present system, RFID labels just act as a bridge to combine segments. It is not required that users carry RFID cards during the entire video capturing period.

The RFID label information can also be used to refine the similar pair and dissimilar pair constraints which are identified in steps 330 and 430. In the preferred embodiment of the identification process using the automatic method mentioned before, for those face images which are marked as similar pairs, if one face image of the pair has a different RFID label than the other face image, then the pair is re-marked as a dissimilar pair. Similarly, if two face images in a dissimilar pair have the same RFID label, this pair will be re-marked as a similar pair. In cases when not all users carry RFID devices, RFID labels need to be associated with the corresponding users. The information on the change of the number of face images can be used to achieve such a goal. For example, if in one frame, there are two faces and only one RFID card is detected, it shows that only one user carries this RFID card. Furthermore, if in next frame, only one face is detected, it is determined whether the current one face is associated with RFID card based on the result of RFID card detection. If an RFID card can still be detected, the current face is associated with the RFID card. Otherwise, the other face in the former frame is associated with RFID card. In accordance with a preferred embodiment, this is denoted as a feedback link. This type of link can assist the system to enhance the collection of the knowledge of similar pair and dissimilar pair constraints.

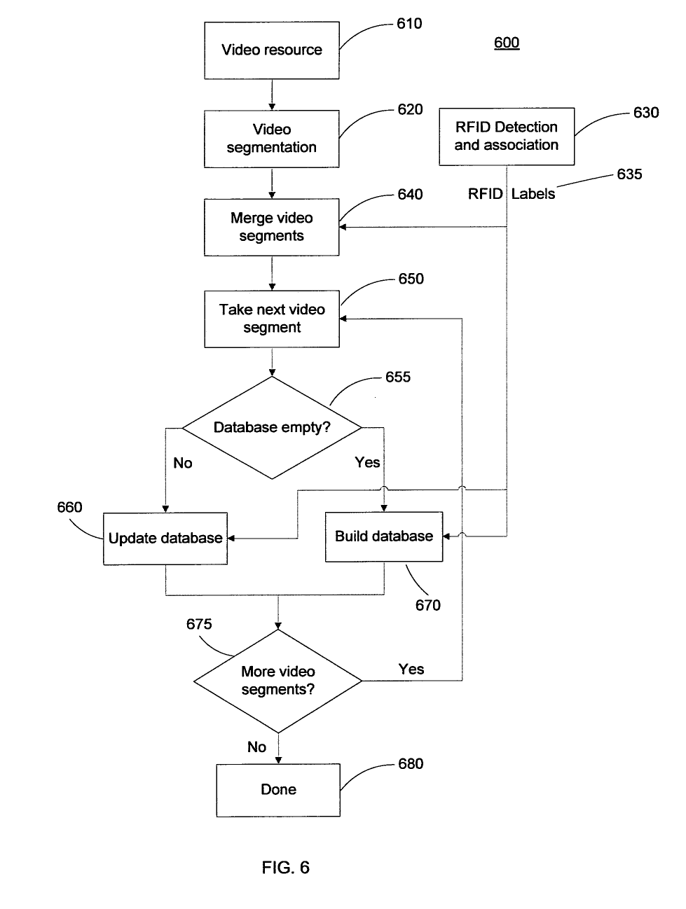

A modified flowchart of the face registration process 600 is illustrated in FIG. 6. A RFID detection and association step 630 is performed to obtain the information on the RFID labels and its correspondence to the video frames. With the RFID label information 635, a merging step 640 of video segments is carried out to combine video segments that are related into larger video segments. The registration system then processes segment by segment based on the combined video segment. The RFID labels 635 are also used in the database building step 670 and updating step 660, wherein the RFID labels 370 and 490 is used to facilitate the similar and dissimilar constraints identification process 330 and 430.

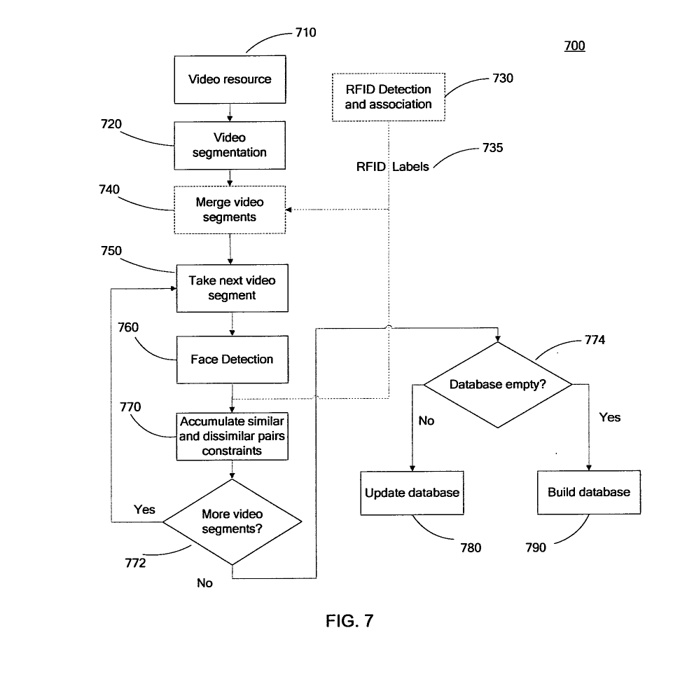

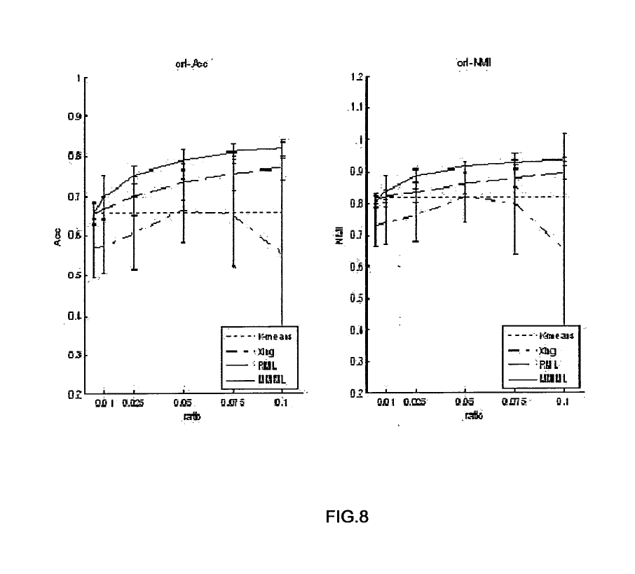

In another embodiment of the invention, the face registration process over a video sequence is conducted according to FIG. 7, wherein the loop over the video segments contains only the face detection 760 and the constraints identification 770. After the face images and constraints are collected from all of the video segments, the database building step 790 and database updating step 780 are initiated based on the condition of whether the database is empty. This embodiment eliminates the number of iterations for learning the distance metric and clustering, and thus provides a more efficient solution. The updating step 780 will be the same as that shown in FIG. 4 except that the face detection step 420 and constraints identification step 430 are skipped. Similarly, the database building step 790 will be the same as that shown in FIG. 3 except that the face detection step 320 and constraints identification step 330 are skipped. When RFID labels are available, the process 700 will utilize the RFID information to perform segment merging 740 to combine related segments into larger and fewer segments before the loop. The constraints identification step 770 also utilizes the RFID label information when it is available.

### Maximum Margin Metric Learning

Every image is a vector in a high dimensional space. Clustering them directly according to the Euclidean metric may result in undesired results, because the distribution of the face images of one person is not spherical but lamellar. The distance between two images of a same person but different conditions is most likely larger than the distance between different persons but under the same conditions. To solve this problem, learning a proper metric becomes critical.

The framework of semi-supervised metric learning described herein is called Maximum Margin Metric Learning (MMML). The main idea is to maximize the margin between the distances of similar sample pairs and the distances of dissimilar sample pairs. It can be solved via semi-positive definite programming. The metric learned according to the rules above is more suitable to cluster images such as face images, than Euclidean metric, because it ensures that the distances of similar pairs are smaller than the distances of dissimilar pairs.

Let X={xⱼ}ⱼ₌₁ⁿ⊂ [symbol] ^{d} be the input data set, and the pair-wise constraints are denoted as follows:

S={(xᵢ,xⱼ)|xᵢ and xⱼ are similar pair samples},

D={(xᵢ,xⱼ)|xᵢ and xⱼ are dissimilar pair samples},

where n is the number of input data set samples. Each xᵢεX is a column vector of d dimensions. S is the set of similar sample pairs, and D is the set of dissimilar sample pairs. The pair-wise constraints can be identified based on prior knowledge according to rules or application background.

The distance metric is denoted by Aε [symbol] ^{d×d}. The distance between two samples xᵢ and xⱼ using this distance metric is defined as:

d_{A}(xᵢ,xⱼ)=∥xᵢ−xⱼ∥_{A}=\sqrt{(xᵢ−xⱼ)′A(xᵢ−xⱼ)}.

To ensure that the distance of every pairs of points in the space [symbol] ^{d} is non-negative, the distance metric A must be positive semi-definite, i.e. A≧0. In fact, A represents the Mahalanobis distance metric, and if A=I, where I is the identity matrix, the distance degenerates to the Euclidean distance.

In order to facilitate clustering, a metric is learned that maximizes the distance between dissimilar pairs, and minimizes the distance between similar pairs. To achieve this goal, the margin between the distances of similar and dissimilar pairs is enlarged. In other words, a metric is to be sought, which gives a maximum blank interval of distance in real axis that the distance of any sample pairs does not belong to it, and distances of similar sample pairs are at one side of it while distances of dissimilar sample pairs are at the other side.

The framework for distance metric learning is formulated as follows:

$${min}_{d , {A}_{0} , {b}_{0}} d$$

$$s . t . {‖ {x}_{i} - {x}_{j} ‖}_{{A}_{0}}^{2} \leq {b}_{0} - d , \begin{matrix}( {x}_{i} , {x}_{j} ) ∈ S & \end{matrix}$$

$${‖ {x}_{i} - {x}_{j} ‖}_{{A}_{0}}^{2} \geq b + d , \begin{matrix}( {x}_{i} , {x}_{j} ) ∈ D & \end{matrix}$$

$$d \geq 0 , \\ {b}_{0} \geq d , \\ A ≽ 0 , \\ Ω ( {A}_{0} ) = 1.$$

The constraints of this optimization problem ensure that the distances of similar pairs are less than b₀−d and the distances of dissimilar pairs are greater than b₀+d. Thus 2d is the width of blank margin to maximize. Ω(A) is a regularizer defined on A, which is a function over A and has the property that Ω(λA) has a positive correlation with a scalar λ, and ensures Ω(A)≠Ω(λA)(λ≠1). The constraint Ω(A₀)=1 is necessary. Without that, any d can be obtained just by multiplying A₀ by λ>0. In one embodiment, the Frobenius Norm of A is used as the regularizer Ω(A), which is defined as

$${‖ A ‖}_{F} = \sqrt{{\sum }_{i , j = 1}^{d} {a}_{ij}^{2}}$$

Denoting

$$b = \frac{{b}_{0}}{d} and A = \frac{{A}_{0}}{d} ,$$

since

$$Ω ( A ) = Ω ( \frac{{A}_{0}}{d} ) ,$$

which is positively correlated to

$$\frac{1}{d} ,$$

the optimizing result of max d is equivalent to min Ω(A). Thus, the framework is equivalent to

$${min}_{A , b} Ω ( A )$$

$$s . t . {‖ {x}_{i} - {x}_{j} ‖}_{A}^{2} \leq b - 1 , \begin{matrix}( {x}_{i} , {x}_{j} ) ∈ S & \end{matrix}$$

$${‖ {x}_{i} - {x}_{j} ‖}_{A}^{2} \geq b + 1 , \begin{matrix}( {x}_{i} , {x}_{j} ) ∈ D & \end{matrix}$$

$$b \geq 1 , \\ A ≽ 0.$$

In real-world applications, most data are non-separable, i.e. a margin cannot be found which satisfies all the constraints above and hence the problem above has no solution in this case. This makes the method proposed above not applicable. To deal with this kind of problem, slack variables are introduced into the framework:

$${min}_{A , b , {ζ}_{ij}} Ω ( A ) + λ {\sum }_{i , j} {ζ}_{ij}^{α}$$

$$s . t . {‖ {x}_{i} - {x}_{j} ‖}_{A}^{2} \leq b - 1 + {ζ}_{ij} , \begin{matrix}( {x}_{i} , {x}_{j} ) ∈ S & \end{matrix}$$

$${‖ {x}_{i} - {x}_{j} ‖}_{A}^{2} \geq b + 1 - {ζ}_{ij} , \begin{matrix}( {x}_{i} , {x}_{j} ) ∈ D & \end{matrix}$$

$${ζ}_{ij} \geq 0 , \\ b \geq 1 , \\ A ≽ 0.$$

where λ is a positive parameter to restrict over fitting, and α is a positive parameter controlling the weight of the punishment.

To simplify the framework, yᵢⱼ is introduced as follows:

$${y}_{ij} = \{ \begin{matrix}1 , & ( {x}_{i} , {x}_{j} ) ∈ S \\ - 1 , & ( {x}_{i} , {x}_{j} ) ∈ D .\end{matrix}$$

Then the framework can be written as

$${min}_{A , b , {ζ}_{ij}} Ω ( A ) + λ {\sum }_{i , j} {ζ}_{ij}^{α}$$

$$s . t . {y}_{ij} {‖ {x}_{i} - {x}_{j} ‖}_{A}^{2} - {y}_{ij} b + 1 \leq {ζ}_{ij} , \\ {ζ}_{ij} \geq 0 , \\ b \geq 1 , \\ A ≽ 0.$$

This is the main form of the framework of Large Margin Metric Learning. It is a convex optimization problem. The semi-definite constraint of the distance metric A limits the problem to be a semi-definite optimization problem. Example tools that can solve this kind of problems can be found in J. Löfberg, “Yalmip: A toolbox for modeling and optimization in MATLAB,” in Proceedings of the CACSD Conference, Taipei, Taiwan, 2004.

### Online Learning Algorithm

An online algorithm is further derived to improve the efficiency of the present method using the idea of stochastic gradient descent method in Shai Shalev-Shwartz, Yoram Singer, and Nathan Srebro. “Pegasos: Primal estimated sub-gradient solver for svm.” In ICML, pages 807-814, 2007. To simplify the computation of solving the gradient, the above framework is rewritten as the loss function style as follows:

$${min}_{A , b} Ω ( A ) + λ {\sum }_{i , j} max {\{ {y}_{ij} [ {‖ {x}_{i} - {x}_{j} ‖}_{A}^{2} - b ] + 1 , 0 \}}^{α}$$

$$s . t . b \geq 1 , \\ A ≽ 0$$

where max {yᵢⱼ[∥xᵢ−xⱼ∥_{A}²−b]+1,0}^{α} is the α hinge loss function, α is a positive parameter. When α=1, the loss function is a hinge loss function. If setting α>1, the loss function becomes smooth. In particular, if α=2, it is called squares hinge loss function, which can be seen as a trade-off between hinge loss and squares loss. When α is getting bigger, the function is more sensitive to large errors. a proper loss function can be easily chosen by adjusting the parameter a. In addition, when a it is more sensitive near the margin if α is getting smaller.

Denote f(A,b) as the objective function in the above framework, and the gradients of f(A,b) with respect to A and b are given by:

$${∇}_{A} f ( A ) = α λ {\sum }_{i , j} {( max \{ {y}_{ij} [ {‖ {x}_{i } - {x}_{j} ‖}_{A}^{2} - b ] + 1 , 0 \} )}^{α - 1} {y}_{ij} ( {x}_{i} - {x}_{j} ) {( {x}_{i} - {x}_{j} )}^{T} + {∇}_{A} Ω ( A )$$

$${∇}_{b} f ( A ) = - α λ {\sum }_{i , j} {( max \{ {y}_{ij} [ {‖ {x}_{i } - {x}_{j} ‖}_{A}^{2} - b ] + 1 , 0 \} )}^{α - 1}$$

The online learning algorithm only considers one constraint in a loop, so there is only one term in the summation function of the gradient. The algorithm is presented in Algorithm 1.

Algorithm 1 Online Learning Algorithm for Maximum Margin Metric Learning

```
Input: pair-wise constraints (xᵢ^{t}, xⱼ^{t}) and yᵢⱼ^{t}, at time t = 1 . . . T;
Output: A_{T};
Initialize A₀ = I, b₀ = 1;
for t = 1 . . . T do
  Solve for the gradient ∇_{A}f(A) and ∇_{b}f(A) as formulated above
  Aₜ = Aₜ₋₁ − αₜ∇_{A}f(A)ₜ₋₁
  bₜ = bₜ₋₁ − αₜ∇_{b}f(A)ₜ₋₁
  Aₜ = SDP(Aₜ) which project Aₜ into the positive semi-definite cone
  bₜ = max{bₜ, 1}
end for
```

In the algorithm, αₜ is an appropriate step length of descent. It can be a function of current iterate times or calculated according to other rules. The common method of projecting A into the positive semi-definite cone is to set all the negative eigenvalues of A to be 0. When the number of features d is large, computing every eigenvalues will cost a lot of time. The present algorithm does not suffer this problem, which can be seen below.

Lemma 1 If Aε [symbol] ^{d×d} is a semi-definite matrix, ∀xε [symbol] ^{d}, the maximum number of negative eigenvalues of B=A−xx^{T} is 1.

It can be inferred from Lemma 1 that the maximum number of negative eigenvalues of A after descent is 1, so that only the minimum eigenvalue and its eigenvector are need to be found. Let e be the eigenvector of negative eigenvalue λₑ. Projecting A into the positive semidefinite cone can be achieved by setting A=A−λₑee^{T}.

### An Example

Below is an example of using the present MMML metric learning method to obtain a distance metric for face image dataset. In this example, the ORL data set is chosen as the input face images, and the dimension of the face image vector is reduced to 30 by using Principle Component Analysis (PCA) method. The pair-wise constraints are generated according to the label information which is already given in the data set. The label information given in the data set is the ground truth for classes of the face images and is called class label. The identified constraints along with the face image data are then used to learn the distance metric according to the invented MMML method. To evaluate the performance of the distance metric learned under the pair-wise constraints, the obtained distance metric is used to cluster the samples by K-means method and the clustered results are called cluster labels. Thus for a face image, it has two labels: a class label which is the ground truth class and a cluster label which is the cluster obtained through clustering using the learned distance metric. The result of clustering is used to show the performance of the metric. To quantitatively evaluate the clustering results, two performance measures are adpoted as follows.

### 1. Clustering Accuracy.

Clustering Accuracy discovers the one-to-one relationship between clusters and classes, and measures the extent to which each cluster contains data points from the corresponding class. Clustering Accuracy is defined as follows:

$$Acc = \frac{{\sum }_{i = 1}^{n} δ ( map ( {r}_{i} ) , l , )}{n}$$

where n is the total number of face images; rᵢ denotes the cluster label of a face image xᵢ; and lᵢ denotes xᵢ's true class label; δ(a,b) is the delta function that equals one if a=b and equals zero otherwise, and map(rᵢ) is the mapping function that maps each cluster label rᵢ to its corresponding class label from the data set.

### 2. Normalized Mutual Information.

The second measure is the Normalized Mutual Information (NMI), which is used for determining the quality of clusters. Given a clustering result, the NMI is estimated by

$$N M I = \frac{{\sum }_{i = 1}^{c} {\sum }_{j = 1}^{c} \frac{{n}_{ij}}{n} log \frac{{n}_{ij} n}{{n}_{i} {\hat{n}}_{j}}}{\sqrt{( {\sum }_{i = 1}^{c} \frac{{n}_{i}}{n} log \frac{{n}_{i}}{n} ) ( {\sum }_{j = 1}^{c} \frac{{\hat{n}}_{j}}{n} log \frac{{\hat{n}}_{j}}{n} )}}$$

where nᵢ denotes the number of data samples (i.e. face images) contained in the cluster Rᵢ, i=1, . . . , c, and c is the total number of clusters. \hat{n}ⱼ is the number of data samples (i.e. face images) belonging to the class Lᵢ, j=1, . . . , c, and nᵢⱼ denotes the number of data that are in the intersection between the cluster Rᵢ and the class L₃. The larger the NMI is, the better the clustering result is obtained.

The experimental results are shown in FIG. 8. The horizontal axis represents the ratio of the number of the constraints generated and used to the maximum number of available constraints. The solid line shows the results of MMML in terms of Acc and NMI, and the dotted line represents the results using Euclidean metric. The other two lines are the results of two prior arts. The figure shows that MMML method performs much better in ORL face data set than others. It can help to get a better result of face registration.

Although preferred embodiments of the present invention have been described in detail herein, it is to be understood that this invention is not limited to these embodiments, and that other modifications and variations may be effected by one skilled in the art without departing from the spirit and scope of the invention as defined by the appended claims.

1. A user interface, comprising:
a database of images corresponding to physical features of users of a system, wherein the physical features of the users differentiate between the users of the system;
a video device for capturing user images when a user interfaces with the system;
a preference analyzer for gathering user preferences of the system on a basis of user interaction with the system and for segregating the preferences to create a set of individual user preferences corresponding to each of the users of the system;
a preference database which stores the individual user preferences relating to use of the system; and
a correlator which correlates the users of the system based on the images in the database of images and applies the individual user preferences related to the particular user of the system which has been captured by the video device when the user interfaces with the system.

2. The user interface of claim 1, wherein the database of images are a database of face images.

3. The user interface of claim 1, wherein the system is a TV set and the user preferences comprise the user's favorite channels, preferred genre of movies and TV programs.

4. A method for user registration comprising the steps of:
accessing a sequence of pictures of users;
detecting images from said sequence of pictures, wherein the images correspond to physical features of users that differentiate between the users;
determining a distance metric using said detected images;
clustering said images based on distances calculated using said distance metric; and,
registering users based on the clustering results.

5. The method of claim 4, wherein the detected images are face images.

6. The method of claim 4, wherein the step of determining a distance metric further comprises the steps of identifying constraints among the detected images; and, learning a distance metric based on the identified constraints.

7. The method of claim 6, wherein the identified constraints comprise similar pairs of detected images and dissimilar pairs of detected images.

8. The method of claim 7, wherein a similar pair of detected images consists of two detected images of the same person.

9. The method of claim 7, wherein a dissimilar pair of detected images consists of two detected images of two different persons.

10. A method for updating user registration comprising the steps of:
accessing a sequence of pictures of users;
detecting images from said sequence of pictures, wherein the images correspond to physical features of users that differentiate between the users;
identifying constraints among detected images;
clustering said images based on distances calculated using an existing distance metric;
verifying said clustering results with said identified constraints; and,
updating the user registration based on said clustering results and verification results.

11. The method of claim 10, wherein the detected images are face images.

12. The method of claim 10, wherein the step of identifying constraints comprises identifying similar pairs of detected images and dissimilar pairs of detected images.

13. The method of claim 12, wherein a similar pair of detected images consists of two detected images of the same person.

14. The method of claim 12, wherein a dissimilar pair of detected images consists of two detected images of two different persons.

15. The method of claim 10, wherein, if said constraints are satisfied in the verifying step, the updating step further comprises updating the user registration by adding the newly clustered images.

16. The method of claim 10, wherein, if said constraints are not satisfied in the verifying step, the updating step further comprises:
learning a distance metric by adding said identified constraints;
re-clustering said images and existing images based on distances calculated using said learned distance metric; and,
updating the user registration using said re-clustering results and said learned distance metric.

17. A method of determining a distance metric, A, comprising the steps of:
identifying a plurality of pairs of points having a distance between the points, wherein the distance between a pair of points (xᵢ,xⱼ), d_{A}(xᵢ,xⱼ), is defined based on the distance metric, A, as
d_{A}(xᵢ,xⱼ)=∥xᵢ−xⱼ∥_{A}=\sqrt{(xᵢ−xⱼ)′A(xᵢ−xⱼ)};
selecting a regularizer of the distance metric A;
minimizing said regularizer according to a set of constraints on the distances, d_{A}, between said plurality of pairs of points to obtain a first value of said regularizer; and,
determining the distance metric, A, by finding the one that achieves a value of said regularizer, which is less than or equal to said first value.

18. The method of claim 17, wherein the regularizer of the distance metric is the Frobenius Norm.

19. The method of claim 17, wherein the points are face images.

20. The method of claim 17, wherein the first value of said regularizer is the minimal value.

21. The method of claim 17, further comprising identifying similar pairs of points and dissimilar pairs of points.

22. The method of claim 21, wherein the set of constraints comprises the distance metric is semi-definite; distances of said identified similar pairs are smaller than or equal to a first non-negative value and distances of said identified dissimilar pairs are larger than or equal to a second non-negative value.

23. The method of claim 17, further comprising selecting a set of slack variables which are combined with the regularizer through a combining function being minimized in the minimizing step.

24. The method of claim 23, further comprising identifying similar pairs of points and dissimilar pairs of points.

25. The method of claim 24, wherein the set of constraints comprises: the distance metric is semi-definite; the slack variables are non-negative; distances of said identified similar pairs are smaller than or equal to a first non-negative value and distances of said identified dissimilar pairs are larger than or equal to a second non-negative value.
